(19) United States
(12) Patent Application Publication
(10) Pub. No.: US 2026/0317164 A1
(43) Pub. Date: Oct. 15, 2026

(54) METHOD FOR GENERATING HYDROGEN FROM BIOMASS MATERIALS

(71) Applicant: MEI LIN Holdings Ltd., Kaohsiung City (TW)

(72) Inventors: Min-Hang Weng, Kaohsiung City (TW); Ru-Yuan Yang, Kaohsiung City (TW)

(73) Assignee: MEI LIN Holdings Ltd., Kaohsiung City (TW)

(21) Appl. No.: 19/178,777

(22) Filed: Apr. 14, 2025

(51) Int. Cl. C01B 3/22

(52) U.S. Cl. CPC C01B 3/22; C01B 2203/0855; C01B 2203/10; C01B 2203/1211; C01B 2203/1258

(57) ABSTRACT

The present disclosure provides a method for generating hydrogen from a biomass material including the following steps: performing a pretreatment process on the biomass material; performing a heating process to heat the pretreated biomass material to a first temperature between 500°C and 600°C under an oxygen-deficient condition; collecting a gaseous substance generated during the heating process; and performing a microwave pyrolysis process to heat the gaseous substance mixed with a catalytic substance to a second temperature between 800°C and 1200°C. The catalytic substance is selected from a carbon-containing substance, a metal particle, a metal oxide powder, or a combination thereof. The method for generating hydrogen from the biomass material is simple, convenient, and energy efficient.

### FIELD

The present disclosure relates to a method for generating hydrogen, and more particularly to a method for generating hydrogen from a biomass material.

### BACKGROUND

As the world moves towards a low-carbon, hydrogen-based transition, the energy industry is actively seeking more cost-effective and sustainable technological solutions. The future applications of hydrogen energy are primarily divided into four major categories: the transportation field, such as various types of vehicles and ships; the distributed energy field, such as charging stations, building-type power generation applications, and large factory power generation; the backup power field, such as communications, emergency backup power, and independent power grids; and the specialized market field, such as emergency power sources and aviation power sources.

Hydrogen can be obtained from diverse and abundant sources and produced by renewable energy sources such as wind power, solar energy, hydropower, or nuclear power. Additionally, hydrogen can be produced from a by-product from traditional chemical industries through processes like pyrolysis processes and reforming processes. After appropriate purification, the produced hydrogen can serve as a source of hydrogen for fuel cells. In addition, hydrogen can be compressed 150 times, 350 times, or even 700 times into a small space due to its gas properties. With the use of a hydrogen cylinder or fuel pipelines for a required driving range, various forms of applications can be developed, enabling quick refueling of hydrogen and making it highly convenient to be use. Compared to electric buses that can only travel up to 200 kilometers and take several hours to charge, hydrogen buses only need 5 to 10 minutes to store hydrogen for travelling 400 kilometers, offering a greater advantage.

Hydrogen can generate electricity through solid oxide fuel cells, in which solid oxides capable of transporting oxygen ions at high temperatures are used as the electrolyte. Typically, hydrocarbons, such as natural gas or coal gas, or hydrogen itself directly serve as the anode fuel gas, while oxygen from the air serves as the cathode oxidant.

Currently, methods for generating hydrogen can be broadly categorized into the following: (1) Grey Hydrogen: Hydrogen is primarily produced through Steam Methane Reforming (SMR), which also generates carbon dioxide as a byproduct; (2) Blue Hydrogen: Hydrogen is produced from fossil fuels and then processed using a carbon capture, storage, and usage (CCSU) mechanism to generate low-carbon hydrogen; (3) Turquoise Hydrogen: Hydrogen is produced using Methane Pyrolysis to generate clean hydrogen; (4) Green Hydrogen: Hydrogen is produced by electrolyzing water using renewable energy to generate zero-emission hydrogen.

Although renewable energy can produce zero-emission green hydrogen by electrolyzing water, the cost of electrolyzing water directly depends on the development and price of renewable energy, and the energy consumption required is 7.6 times that of methane pyrolysis technology. For regions where renewable energy is not yet widespread, methane pyrolysis offers a highly cost-effective alternative for producing clean hydrogen.

Traditional methane pyrolysis technology involves decomposing or pyrolyzing methane (CH₄) into hydrogen (H₂) and carbon (C) elements at high temperatures ranging from 800° C to 1600° C and is a cost-effective, low-carbon emission hydrogen production technology. Methane pyrolysis technology not only produces clean hydrogen but also generates solid carbon as a byproduct, which can be directly and widely applied in various fields such as electronics, energy storage systems, tire production, agricultural additives, and construction materials, thereby creating value.

Organic waste and other biomass materials are rich sources of hydrogen. After undergoing recycling processes, the resulting products can not only generate profits but also reduce pollution. Typically, the addition of a catalyst can selectively promote the breaking of carbon-hydrogen bonds in biomass to produce hydrogen. However, the current traditional method for thermally decomposing biomass materials produces a variety of impure bio-gases, which are not entirely high-quality hydrogen.

Accordingly, it is necessary to provide a method capable of producing high-quality hydrogen from biomass materials.

### SUMMARY

In order to solve the aforementioned issues, the primary objective of the present disclosure is to provide a method for generating hydrogen from a biomass material. The provided method involves pyrolysis of a biomass material to generate a solid product, a liquid product (i.e., bio-oil), and a gaseous product (i.e., syngas). In this method, the gaseous product generated from the pyrolysis of the biomass material is further processed with a second pyrolysis to effectively generate high-quality hydrogen.

In order to achieve the primary objective of the present disclosure, the present disclosure provides a method for generating hydrogen from a biomass material including the following steps:

Step (1): Perform a pretreatment process on the biomass material;

Step (2): Perform a heating process to heat the pretreated biomass material to a first temperature between 500° C and 600° C under an oxygen-deficient condition;

Step (3): Collect a gaseous substance generated during the heating process; and

Step (4): Perform a microwave pyrolysis process to heat the gaseous substance mixed with a catalytic substance to a second temperature between 800° C and 1200° C.

The catalytic substance is selected from a carbon-containing substance, a metal particle, a metal oxide powder, or a combination thereof.

According to one aspect of the present disclosure, in step (1), the pretreatment process includes a dewatering process to reduce moisture content of the biomass material to a range between 40% and 20%.

According to one aspect of the present disclosure, in step (1), the pretreatment process includes a crushing process to break the biomass material into pieces smaller than 10mm.

According to one aspect of the present disclosure, the carbon-containing substance is selected from carbon black, graphite, activated carbon, carbon fiber, or a combination thereof.

According to one aspect of the present disclosure, the metal particle is selected from a transition metal substance, a nano-metal substance, or a combination thereof.

According to one aspect of the present disclosure, the metal oxide powder is selected from magnesium oxide, calcium oxide, strontium oxide, barium oxide, aluminum oxide, silicon oxide, iron oxide, zirconium oxide, vanadium oxide, titanium oxide, manganese oxide, cobalt oxide, nickel oxide, magnesium carbonate, calcium carbonate, strontium carbonate, barium carbonate, aluminum carbonate, or from other oxides or other oxycarbonate materials with high dielectric constants, or a combination thereof.

According to one aspect of the present disclosure, in step (1), the oxygen-deficient condition refers to a condition in which an oxygen amount is less than one-third of an oxygen amount in normal air during a heating process.

According to one aspect of the present disclosure, in step (4), a heating rate of the microwave pyrolysis process is between 20° C per minute (° C/min) and 80° C per minute (° C/min).

According to one aspect of the present disclosure, in step (4), a microwave power density of the microwave pyrolysis process is between 1kW per kilogram of hydrogen (kW/kg of hydrogen) and 20kW per kilogram of hydrogen (kW/kg of hydrogen).

According to one aspect of the present disclosure, in step (4), a heating rate of the microwave pyrolysis process is between 60° C per minute (° C/min) and 80° C per minute (° C/min), and a microwave power density of the microwave pyrolysis process is between 10kW per kilogram of hydrogen (kW/kg of hydrogen) and 20kW per kilogram of hydrogen (kW/kg of hydrogen).

The method for generating hydrogen from a biomass material of the present disclosure has the following advantages:

The thermal efficiency of the microwave pyrolysis process is extremely high, and the hydrogen production efficiency is excellent.

The energy consumption of the microwave pyrolysis process is extremely low, and there are no issues such as carbon dioxide emissions.

Hydrogen produced by the microwave pyrolysis process is of higher quality compared to traditional heating methods.

### BRIEF DESCRIPTION OF THE DRAWINGS

In order to make the above and other objectives, features, and advantages of the present disclosure more apparent and understandable, several preferred embodiments are described below in detail with reference to the accompanying drawings.

FIG. 1 shows a flowchart of a method for generating hydrogen according to the present disclosure.

### DETAILED DESCRIPTION

Although the present disclosure can be embodied in different forms, the drawings and the descriptions herein are the preferred embodiments of the present disclosure. Those skilled in the art will understand that the devices and methods specifically described herein and illustrated in the drawings are considered as examples of the present disclosure and are not limiting exemplary embodiments, and the scope of the present disclosure is defined solely by the claims. The features illustrated or described in connection with one exemplary embodiment can be combined with features of other embodiments. Such modifications and variations will fall within the scope of the present disclosure.

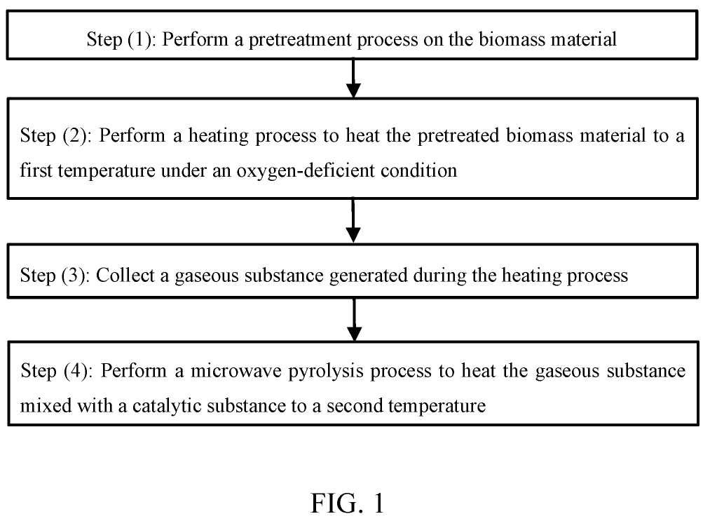

FIG. 1 show a method for generating hydrogen from a biomass material, and the method includes the following steps:

Step (1): Perform a pretreatment process on the biomass material;

Step (2): Perform a heating process to heat the pretreated biomass material to a first temperature between 500° C and 600° C under an oxygen-deficient condition;

Step (3): Collect a gaseous substance generated during the heating process; and

Step (4): Perform a microwave pyrolysis process to heat the gaseous substance mixed with a catalytic substance to a second temperature between 800° C and 1200° C.

The catalytic substance is selected from a carbon-containing substance, a metal particle, a metal oxide powder, or a combination thereof.

According to one aspect of the present disclosure, in step (1), the pretreatment process includes a dewatering process to reduce moisture content of the biomass material to a range between 40% and 20%.

According to one aspect of the present disclosure, in step (1), the pretreatment process includes a crushing process to break the biomass material into pieces smaller than 10mm.

The biomass material generally refers to the residues of animals, plants, and microorganisms or the waste substances generated from their natural activities, such as useless, unwanted, or discarded substances produced during production or consumption processes, and the waste substances include gaseous waste, liquid waste, and solid waste. The biomass material can be categorized into three main types: industrial biomass materials, agricultural biomass materials, and domestic biomass materials. The sources of industrial biomass materials come from food factories, breweries, slaughterhouses, restaurants, markets, hospitals, hotels, biological sludge, etc. The sources of agricultural biomass materials come from gardens, fruits farms, vegetables farms, mushroom farms, forestry, chicken farms, cattle farms, sheep farms, etc. The sources of domestic biomass materials come from kitchen waste, government agencies, military units, schools, prisons, communities, etc.

Step (1) includes a dewatering process and a crushing process. The dewatering process is performed to reduce moisture content of the biomass material to a range between 40% and 20%. Preferably, the dewatering process is performed to reduce moisture content of the biomass material to a range between 50% and 30% to shorten the time required for a subsequent pyrolysis reaction. The dewatering process refers to reducing moisture content of the biomass material, which can be a mechanical dewatering process or a drying dewatering process. The principles of the mechanical dewatering process can be primarily divided into three major categories: vacuum filtration dewatering, pressure filtration dewatering, and centrifugal dewatering. The vacuum filtration dewatering, also known as reduced-pressure filtration, utilizes a suction decompression device to partially remove air from a lower chamber, creating a pressure difference that accelerates liquid filtration under the combined effects of gravity and pressure difference, thereby achieving the goal of rapidly separating liquid from solid precipitates. The pressure filtration dewatering consists of components such as a frame, a filter plate, and a filter cloth. When the material to be treated is pressed against the filter cloth, larger particles form a bridging effect in front of the pores of the filter cloth, thereby creating a filter cake and achieving solid-liquid separation. The centrifugal dewatering primarily relies on the centrifugal force generated by high-speed rotation, which causes solid particles to be thrown against the inner wall to form a solid layer, thereby achieving dewatering. The drying dewatering process employs heating methods, such as sun drying, hot air drying, furnace heating, electric heating, and microwave drying. Generally, the material is dried at high temperatures ranging from 100° C to 150° C for about 10 to 30 minutes, thereby allowing moisture in the biomass material to evaporate and achieving the goal of dewatering. Preferably, in one embodiment of the present disclosure, in order to achieve rapid dewatering, the dewatering process employs microwave drying to reduce moisture content of the biomass material to a range between 40% and 20%.

The crushing process is performed to break the biomass material into a smaller size. Since the biomass material is not a homogeneous substance, its different shapes and structures may affect heat transfer, which may further influence the effect of thermal pyrolysis. Therefore, it is necessary to crush larger biomass materials to a smaller size that allows for uniform mixing. The crushing process employs mechanical processing and can be performed by using grinders, crushers, and shredders. The crushing process is performed to break down the biomass material into pieces smaller than 10mm, preferably smaller than 5mm.

In step (2), the oxygen-deficient condition is performed by using a restricted air intake design or by introducing an inert gas for heating the pretreated biomass material to a first temperature between 500° C and 600° C. The heating process includes furnace pyrolysis, electric heating pyrolysis, infrared pyrolysis, or microwave pyrolysis. Pyrolysis is a thermochemical reaction process that decomposes organic materials into biochar, bio-oil, and combustible gases under high-temperature, oxygen-free, or oxygen-deficient conditions. The oxygen-deficient condition refers to a condition in which an oxygen amount within a heating chamber is less than that in normal air during a heating process. In the present embodiment, the oxygen-deficient condition refers to a condition in which an oxygen amount is less than one-third of an oxygen amount in normal air. Preferably, the oxygen-deficient condition refers to a condition in which an oxygen amount is less than one-tenth of an oxygen amount in normal air. The oxygen-deficient condition can also be achieved through a restricted air intake design, meaning that during the heating process, air within the heating chamber is only extracted without intaking any gas into the heating chamber during the thermochemical reaction process. In other words, the restricted air intake design can be achieved by completely exhausting the oxygen without replenishing subsequent oxygen. The oxygen-deficient condition can also be maintained by continuously introducing an inert gas, such as nitrogen or argon, with a flow rate proportional to a capacity of the heating chamber.

In step (3), a gaseous substance generated during the heating process is collected. In step (2), the biomass material is decomposed into a solid substance, a liquid substance, and a gaseous substance under the oxygen-deficient condition. The liquid substance is namely bio-oil, and the gaseous substance is namely syngas, which primarily includes hydrogen, methane, and carbon monoxide. The solid substance may be biochar material or similar to biochar material.

In step (4), the microwave pyrolysis process includes heating the gaseous substance to a temperature between 800° C and 1200° C under the oxygen-deficient condition. The microwave is a type of electromagnetic wave. Further, the microwave pyrolysis process utilizes the principle of radiation, where microwaves enter the interior of a material through the surface of the material. The material then absorbs the energy of the microwaves and converts it into heat, achieving the goal of heating. The pyrolysis of the gaseous substance begins to react under high temperature and oxygen deficient conditions. The temperature of the heating process can be adjusted and controlled within a range between 800° C and 1200° C, and the heating process can be maintained for a period of time. Preferably, the microwave pyrolysis process includes heating the liquid substance to a temperature between 900° C and 1000° C under the oxygen-deficient condition.

Step (4) further includes: adding a catalytic substance. The catalytic substance is selected from a carbon-containing substance, a metal particle, a metal oxide powder, or a combination thereof. The catalytic substance can absorb the energy of the microwaves to accelerating the reaction rate of the thermochemical reaction process. The carbon-containing substance has a size ranging from 10 nanometers to 10 centimeters and can be selected from carbon black, graphite, activated carbon, carbon fiber, or a combination thereof. The metal particle has a size ranging from 10 nanometers to 10 centimeters and can be selected from a transition metal material, a nano-metal material, or a combination thereof. The metal particle has a size ranging from 10 nanometers to 10 centimeters and can be selected, for example, from carbon iron, nickel-copper-zinc ferrite, nickel-zinc ferrite, manganese-zinc ferrite, a related metal substance, a nano-metal substance, or a combination thereof. The metal oxide powder can be selected from magnesium oxide, calcium oxide, strontium oxide, barium oxide, aluminum oxide, silicon oxide, iron oxide, zirconium oxide, vanadium oxide, titanium oxide, manganese oxide, cobalt oxide, nickel oxide, magnesium carbonate, calcium carbonate, strontium carbonate, barium carbonate, aluminum carbonate, or from other oxides or other oxycarbonate materials with high dielectric constants, or a combination thereof. The amount of the catalytic substance added to the biomass material after the pretreatment process is between 2% and 30% of the weight of the pretreated biomass material. Preferably, the amount of the catalytic substance added to the biomass material after the pretreatment process is between 5% and 10% of the weight of the pretreated biomass material.

The catalytic substance is a network metal with a decomposition temperature that can reach up to 1800° C. A solid product generated may be a carbon nanotube with relatively good crystallinity, particularly multi-walled carbon nanotubes. Although the generated solid product, which is mainly carbon, accumulates on the surface of the catalytic substance, causing the metal materials or metal oxides to lose catalytic activity, the generated solid product has a strong microwave absorption capability. Therefore, the generated solid product can continue to act as a catalytic substance to accelerate the pyrolysis reaction.

According to one aspect of the present disclosure, in step (4), a heating rate of the microwave pyrolysis process is between 20° C per minute (° C/min) and 80° C per minute (° C/min), preferably between 60° C per minute (° C/min) and 80° C per minute (° C/min). According to one aspect of the present disclosure, in step (4), a microwave power density of the microwave pyrolysis process is between 1kW per kilogram of hydrogen (kW/kg of hydrogen) and 20kW per kilogram of hydrogen (kW/kg of hydrogen), preferably between 10kW per kilogram of hydrogen (kW/kg of hydrogen) and 20kW per kilogram of hydrogen (kW/kg of hydrogen).

The hydrogen can be obtained at a lower cost. The method for generating hydrogen from a biomass material involves pyrolysis, particularly microwave pyrolysis, of a biomass material to generate a solid product, a liquid product (i.e., bio-oil), and a gaseous product (i.e., syngas). In this method, the gaseous product generated from the pyrolysis, particularly microwave pyrolysis, of the biomass material is further processed with a second pyrolysis to effectively generate high-quality hydrogen. In other words, the present embodiments disclose that high-quality, low-cost hydrogen can be obtained from biomass materials through a two-stage heating processes.

The method for generating hydrogen from a biomass material of the present disclosure has the following advantages:

The thermal efficiency of the microwave pyrolysis process is extremely high, and the hydrogen production efficiency is excellent.

The energy consumption of the microwave pyrolysis process is extremely low, and there are no issues such as carbon dioxide emissions.

Hydrogen produced by the microwave pyrolysis process is of higher quality compared to traditional heating methods.

Although the present disclosure has been disclosed in the preferred embodiments described above, these embodiments are not intended to limit the present disclosure. Any person skilled in the art can make various modifications and changes without departing from the spirit and scope of the present disclosure. As described above, various types of modifications and changes can be made without compromising the spirit of the present disclosure. Therefore, the scope of the present disclosure shall be defined by the appended claims.

What is claimed is:

1. A method for generating hydrogen from a biomass material, the method comprising:
performing a pretreatment process on the biomass material;
performing a heating process to heat the pretreated biomass material to a first temperature between 500° C and 600° C under an oxygen-deficient condition;
collecting a gaseous substance generated during the heating process; and
performing a microwave pyrolysis process to heat the gaseous substance mixed with a catalytic material to a second temperature between 800° C and 1200° C;
wherein the catalytic substance is selected from a carbon-containing substance, a metal particle, a metal oxide powder, or a combination thereof.

2. The method of claim 1, wherein the pretreatment process includes a dewatering process to reduce moisture content of the biomass material to a range between 40% and 20%.

3. The method of claim 1, wherein the pretreatment process includes a crushing process to break the biomass material into pieces smaller than 10mm.

4. The method of claim 1, wherein the carbon-containing substance has a size ranging from 10 nanometers to 10 centimeters and is selected from carbon black, graphite, activated carbon, carbon fiber, or a combination thereof.

5. The method of claim 1, wherein the metal particle has a size ranging from 10 nanometers to 10 centimeters and is selected from a transition metal substance, a nano-metal substance, or a combination thereof.

6. The method of claim 1, wherein the metal oxide powder has a size ranging from 10 nanometers to 10 centimeters and is selected from magnesium oxide, calcium oxide, strontium oxide, barium oxide, aluminum oxide, silicon oxide, iron oxide, zirconium oxide, vanadium oxide, titanium oxide, manganese oxide, cobalt oxide, nickel oxide, magnesium carbonate, calcium carbonate, strontium carbonate, barium carbonate, aluminum carbonate, an oxide material, an oxycarbonate material, or a combination thereof.

7. The method of claim 1, wherein the oxygen-deficient condition is a condition in which an oxygen amount is less than one-third of another oxygen amount in normal air during the heating process.

8. The method claim 1, wherein a heating rate of the microwave pyrolysis process is between 20° C per minute and 80° C per minute.

9. The method claim 1, wherein a microwave power density of the microwave pyrolysis process is between 1kW per kilogram of hydrogen and 20kW per kilogram of hydrogen.

10. The method of claim 1, wherein a heating rate of the microwave pyrolysis process is between 60° C per minute and 80° C per minute, and a microwave power density of the microwave pyrolysis process is between 10kW per kilogram of hydrogen and 20kW per kilogram of hydrogen.
